(19) United States
(12) Patent Application Publication
(10) Pub. No.: US 2009/0031148 A1
(43) Pub. Date: Jan. 29, 2009

(54) Distributed Electrical Power System for Computer Rooms

(76) Inventor: Brian Richard Densham, Ajax (CA)

Correspondence Address: GOWAN INTELLECTUAL PROPERTY, 1075 NORTH SERVICE ROAD WEST, SUITE 203, OAKVILLE, ON, L6M-2G2, CA

(21) Appl. No.: 11/829,068

(22) Filed: Jul. 26, 2007

(51) Int. Cl. G06F 1/26

(52) U.S. Cl. 713/300

(57) ABSTRACT

A scalable electrical power distribution system for air conditioned computer rooms has an uninterruptible power supply and at least one rack mounted power distribution unit to supply conditioned power to the critical loads. If the power demand of the rack mounted critical loads connected to any rack mounted power distribution unit exceeds the power rating of that unit, a further rack mounted power distribution unit may be placed in another cabinet so as to distribute conditioned electrical power to additional rack mounted critical loads. The power distribution system is scalable as to the number of rack mounted power distribution units that may be installed in the computer room; it reduces initial capital costs, and eliminates cable congestion below the raised floor of the computer room.

### FIELD OF THE INVENTION

This invention relates to computer rooms, and particularly relates to power distribution systems for distributing conditioned electrical power to critical loads such as computer servers or other computer-related devices that are rack mounted in a computer room. The present invention provides for a scalable power distribution system whereby only the necessary power rating for distributed power distribution units, and in some cases only the necessary power rating for an uninterruptible power supply, needs to be installed for a given power requirement of rack mounted critical loads in the computer room. Thus, initial capital costs may be reduced; and as the computing power requirements and the necessity for additional servers and other computer-related devices grow, all of which are rack mounted in standard computer room cabinets, then additional rack mounted power distribution units may be installed to provide additional conditioned electrical power for the growing number of rack mounted critical loads, all in keeping with the present invention.

### BACKGROUND OF THE INVENTION

Computer rooms are well known to those technicians, designers, and suppliers who provide Information Technology services to enterprises that require large installed centralized computing power. Such users include banks, universities, governments and their agencies, large courier services, manufacturing companies of all sorts, particularly those that require storage of huge amounts of data, or those that use computer-driven robotics, and so on. A typical computer room installation requires that the cabinets for the rack mounted computing devices of all sorts are placed on a raised floor—that is, the floor of the computer room is raised off the original floor of the building. The reason is that the cabling that is required for the installed computers may be very extensive, and must be placed so as not to lie on the floor. As well, it is necessary for the efficient operation of the computers that they be cooled, and the necessary cooled and humidified air at predetermined temperatures and humidity levels is blown through the passage which exists between the original floor of the building and the raised floor upon which the computer cabinets having rack mounted computing devices of all sorts are placed.

It may happen that a computer room or data centre may comprise only a small number of computer cabinets with rack mounted computing mounted therein, and in that case the computer cabinets may be placed directly on the original floor, with the power cabling also being placed on the floor. Even in such cases, as will be clearly understood hereafter, the present invention will preclude the necessity for a floor mounted power distribution unit, and permit the placement of the power and other cabling overhead, thus removing a tripping hazard among other things.

A typical computer room may have as few as just a couple of computer cabinets, or it may have 20 or 30 computer cabinets, or it may have several hundred computer cabinets placed therein. Each one of those computer cabinets requires that electrical power shall be delivered to it from a power distribution unit which may be placed anywhere in the computer room. The power distribution unit may be placed in the computer room in relative proximity to the rack mounted computing devices in each computer cabinet to which electrical power will be delivered; or the power distribution unit may be remotely placed relative to the rack mounted computing devices, or it may even be wall mounted. In any event, until now, power has been delivered from the power distribution unit to each respective computer cabinet using a dedicated power cable which is located beneath the raised floor.

Obviously, when there is only a single power distribution unit located within the computer room, the dedicated power cables must have appropriate lengths to reach from the power distribution unit to the respective computer cabinet and the critical load computing devices mounted therein. In some instances, such dedicated power cables may have a length of only a few meters, or even up to 35 meters. Moreover, each dedicated power cable must be identified by appropriate labelling means. Each dedicated power cable must originate and terminate in appropriate electrical power boxes of the sort known to those skilled in the electrical field. Still further, because the dedicated power cables may deliver conditioned electrical power having voltage which can be harmful to humans (typically 110 V or 220 V) and high current flow, which may be delivered in single phase or three-phase configuration, those dedicated power cables may only be installed or uninstalled by certified electricians. That means, of course, that in the event that the computer cabinets may be moved or, more particularly, in the event that additional computer cabinets are required to be installed, then no work can be done until a certified electrician is on site. It should also be noted that because the dedicated power cables must be provided in specified lengths, their cost may be as much as $500 or more. Thus, even a relatively small computer room having, say, 30 computer cabinets has a capital cost just for the dedicated power cables in the range of $15,000.

Even further, the prior art dedicated power cables have been specified and supplied in specific sizes so as to carry the expected current to its intended computer cabinet, with the foreknowledge of the power requirement of that computer cabinet. However, the computer industry is a volatile one, and requirements for servers or other computing devices mounted in that specific computer cabinet may change, requiring delivery of even more power. That will result in the requirement for a certified electrician to remove the prior dedicated cable and place a new dedicated cable, and probably also to replace a branch circuit breaker that is associated with that dedicated cable. Understandably, therefore, the original capital costs of supplying all the necessary dedicated cables in the first instance, or the cost of changing them, is high, and may constitute a relatively substantial portion of the entire cost of the data centre which is installed in the computer room.

Typically, the user of the computers, and the designers and suppliers for that user, will estimate the ultimate size to which the computer room may grow, and therefore the number of computer-related devices that may be required to be installed in a given number of cabinets, and the electrical power requirements for that installation. However, very often the initial installed computing power may only be a fraction of what is estimated to be the ultimate installed computing power, so there may be large areas in the computer room having nothing installed therein. But, since the ultimate installed computing power is known, and therefore its ultimate power requirements are known, the typical initial capital installation for a computer room includes an uninterruptible power supply having a power rating up to that which will ultimately be required, and a power distribution unit also having a power rating up to that which will ultimately be required. If the initial installed computing power in a computer room is only, say, 30% of what the ultimate computing power will be, then a conditioned electrical power supply having 70% higher power rating then required at that time, will probably have been installed. Indeed, in many cases 70% more power cables and other required cabling may also be installed. Obviously, this requires additional capital expenses beyond that which is appropriate at the time of the initial computer room design and installation.

It will be easily understood that the presence of so many cables that are installed beneath the floor of the computer room is such that they will impede the flow of cooling air which is delivered through the same passage, as is commonly done.

The inventor herein has unexpectedly discovered that a much simpler and less capital cost intensive solution is available, whereby a scalable power distribution system for delivering conditioned electrical power to the rack mounted critical loads in a computer room, is provided in which a plurality of power distribution units are rack mounted in the same cabinets as the rack mounted critical loads. Each of the power distribution units has a power rating which is sufficient only to serve a predetermined requirement for conditioned electrical power; which means that only a given number of rack mounted critical loads may be supplied from any given power distribution unit. On the other hand, as the requirement for computing power increases, or if computing devices must be replaced with others that have higher power consumption, then additional cabinets and additional power distribution units may be installed at that time, thereby reducing initial capital costs and withholding the additional requisite capital costs until they are required.

Moreover, by following the teachings of the present invention, higher efficiency cooling for the computer room is possible, because the present invention avoids cable congestion in the passage between the original floor of the building and the installed raised floor. Thus, greater flow of cooled and humidified air through the passage is possible, and in some cases with lower power requirements for the air blowers because there is less impedance to air flow than in a conventional prior art computer room installation.

Also, it has been possible, in the recent past, that there may have been more than one power distribution unit in place in a computer room; but if so, each power distribution unit has been installed in a special cabinet designed specifically for that power distribution unit. That is in contradistinction to the present invention, by which it is possible to install power distribution units in conventional rack mounting computer cabinets, and to move the power distribution units from one cabinet to another if necessary.

### SUMMARY OF THE INVENTION

In accordance with one aspect of the present invention, there is provided a scalable electrical power distribution system for use in computer rooms in which a plurality of computer servers and other computer-related devices are mounted in standard racks and cabinets therefor

The power distribution system comprises an uninterruptible power supply for delivering conditioned electrical power to rack mounted critical loads in the computer room, which critical loads may be computer servers and other computer-related devices.

There is at least one power distribution unit interposed between the uninterruptible power supply and the critical loads, and adapted to distribute up to a predetermined amount of conditioned electrical power to a plurality of rack mounted critical loads, and to interpose an electrical breaker between the power distribution unit and each rack mounted critical load or a predetermined group of rack mounted critical loads.

The power distribution unit is rack mounted in a cabinet which may also include at least one rack mounted critical load mounted therein.

The power distribution system is such that, when the power demand of the rack mounted critical loads connected to the at least one power distribution unit exceeds the predetermined amount of conditioned electrical power, a further rack mounted power distribution unit may be placed in a further cabinet and connected to the uninterruptible power supply so as to distribute conditioned electrical power through breakers to the additional rack mounted critical loads.

Each power distribution unit that is employed in keeping with the present invention is such that it may be mounted in any cabinet in the computer room, and it may be moved from one cabinet to another.

Thus, the electrical power distribution system is scalable as to the number of rack mounted critical loads and their associated rack mounted power distribution units that may be installed in the computer room.

Typically, in most computer rooms, the plurality of cabinets are positioned on a raised floor below which is a passage in which electrical cabling may be placed, and through which conditioned air having a predetermined temperature and humidity is blown.

The scalable electrical power distribution system of the present invention is such that only the necessary electrical power supply cabling for the uninterruptible power supply is placed in the passage below the raised computer room floor, and the power distribution cabling and any other computer-related cabling for the rack mounted critical loads associated with each rack mounted power distribution unit may be placed in the passage, above the floor, or most usually above the cabinets in which the respective rack mounted critical loads for each respective rack mounted power distribution unit are mounted.

The scalable electrical power distribution system of the present invention typically requires that there is a cabinet power bus mounted in each cabinet, and the power for each cabinet is delivered to the respective cabinet power bus from the rack mounted power distribution unit.

In keeping with the present invention, when the rack mounted critical load power requirements exceed the power rating of the uninterruptible power supply and the installed rack mounted power distribution units, the uninterruptible power supply may be replaced, or an additional uninterruptible power supply may be put into place in the computer room to be associated with additional rack mounted power distribution units as required.

Finally, a provision of the scalable electrical power distribution system of the present invention is that redundancy may be installed, by placing two rack mounted power distribution units in parallel for each group of rack mounted critical loads associated with any one rack mounted power distribution unit.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a diagrammatic elevation view of a typical prior art power distribution installation in a computer room;

FIG. 2 is a diagrammatic elevation view of a power distribution system installation in keeping with the present invention;

FIG. 3 is a block schematic showing a typical power distribution system installation in keeping with the present invention;

FIG. 4 is a diagrammatic plan view of a typical prior art power distribution installation in a computer room;

FIG. 5 is a diagrammatic plan view of a power distribution system installation in keeping with the present invention; and

FIG. 6 is a perspective view of a portion of a typical power distribution system installation in keeping with the present invention.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following discussion.

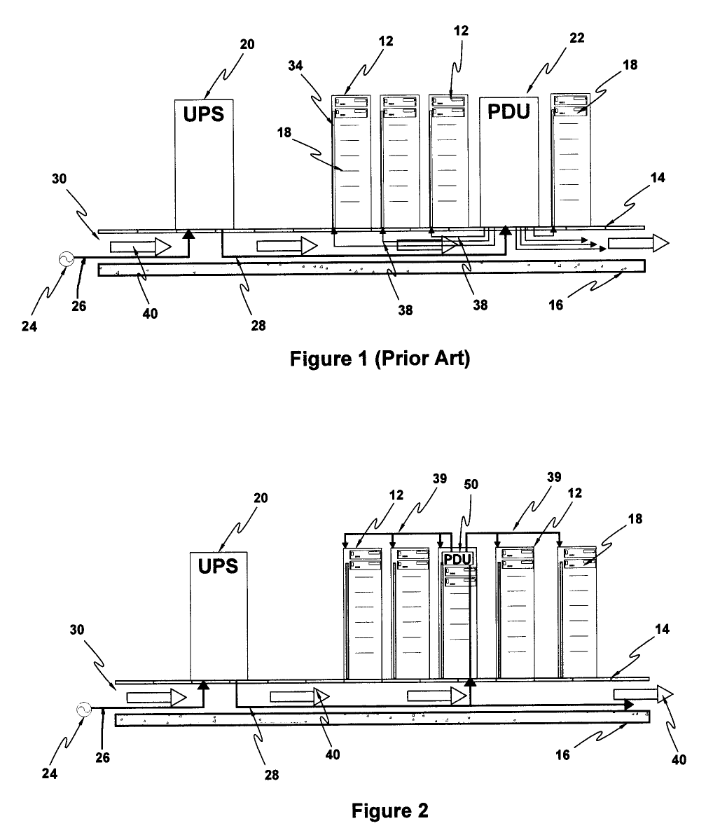

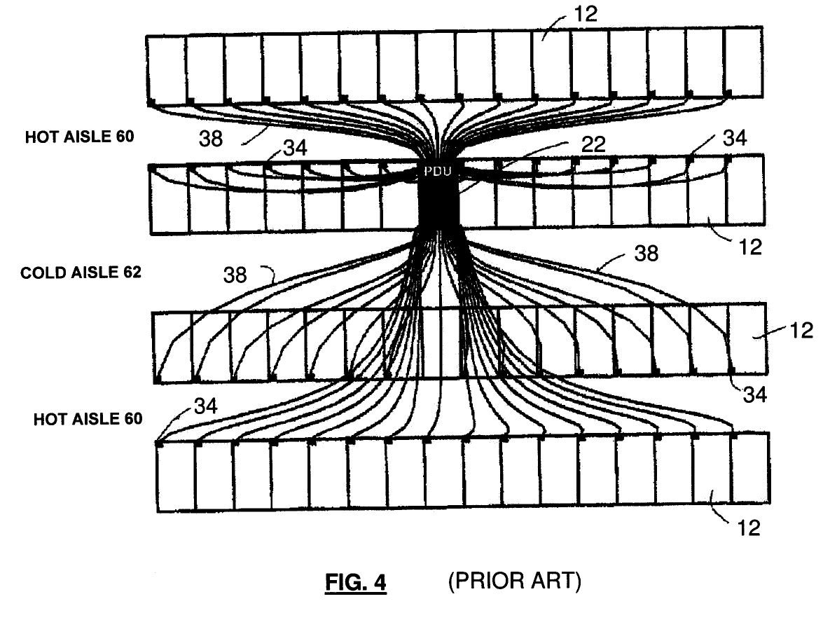

Turning first to FIGS. 1 and 4, a typical prior art installation of a power distribution system for a computer room, as they presently exist, is shown. A number of standard rack mounting cabinets are indicated at 12, and they are placed on a raised floor 14 which is elevated above the original floor 16 of the building in which the computer room exists. Typically, the original floor 16 is cast concrete; and the raised floor 14 is built on a plurality of stanchions, girders, floor panels, etc., as is well known to those skilled in the art.

An uninterruptible power supply 20 is placed on the floor 14, although in some installations the uninterruptible power supply may be placed in its own enclosure in the computer room or even in a separate room. In any event, there is also a power distribution unit 22 which is typically centrally placed in the computer room so as to provide conditioned electrical power to all of the critical rack mounted loads 18 which are found in each of the cabinets 12.

The electrical power supply to the uninterruptible power supply 20 is typically purchased from the local power utility, and is typically provided as three-phase power 24, which is delivered to the uninterruptible power supply 20 via cable 26. Because of the prospective power rating of the uninterruptible power supply 20, it may be that the cable 26 is very large—having a diameter as much as 3 or 5 cm, or even more. A similar cable 28 is run to the power distribution unit 22; and it will be noted that those cables and others which are described later are all installed in the passage 30 which is found below the raised floor 14 and above the original floor 16. Because the computer room may be large, or is expected to have a large number of cabinets 12 installed therein, it is typical to place all of the cabling which is required for power delivery from the uninterruptible power supply to the power distribution unit, and from the power distribution unit to each of the cabinets 12, as well as all of the necessary monitoring cables, etc., within the passage 30. This is particularly so as to avoid tripping hazards in the computer room as technicians move from cabinet to cabinet, as well as to keep the computer room looking reasonably neat, to assist cleaning of the room such as by mopping the floor, and so on.

Typically, each cabinet 12 is provided with a cabinet power bus 34, and each of the critical loads 18 is plugged into the cabinet power bus 34 in a manner well known to those skilled in the art. Conditioned electrical power for each cabinet 12 is delivered thereto, and the monitored status of each cabinet and the rack mounted critical loads 18 mounted therein, is carried out through cabling 38. It will be noticed that there is at least one cable set 38, which may include the necessary power cables and the necessary monitoring wires, for each cabinet 12. It will be seen from FIGS. 1 and 4 that there may be considerable cable congestion within the passage 30.

Moreover, it will be understood that each individual length of cabling 38 is a dedicated power cable, having a predetermined length and size which are determined by the power consumption requirements of each respective computer cabinet, and its placement relative to the power distribution unit. Thus, each dedicated power cable is terminated at each end in a suitable electric box (not shown), and must be installed by a certified electrician.

It has been noted previously that the passage 30 also provides the pathway through which conditioned and humidified air is blown, as shown by arrow 40. Obviously, the cable congestion within the passage 30 impedes the flow of conditioned air, leading either to the requirement for more powerful blowers, or to less efficient cooling of the cabinets 12 and the rack mounted critical loads 18 mounted therein, or both. It has also been noted that the original installation of the uninterruptible power supply 20, and more particularly of the original power distribution unit 22, may typically have been an overrated device so as to accommodate future installation of additional cabinets 12 and rack mounted critical loads 18. Still further, so as to avoid having to lift portions of the raised floor 14, additional dedicated power cabling 38 may also have been already installed in the passage 30 and terminated at suitable boxes or other termination points as discussed above, and as well known to those skilled in the art.

Accordingly, there are at least two issues to be addressed in order to avoid capital costs higher than they need be, and to provide more efficient flow of conditioned and humidified air to the rack mounted critical loads. The present invention addresses both of those issues by providing that only the necessary number of the rack mounted power distribution units having the appropriate power ratings for the then installed rack mounted critical loads need to be installed in the original installation of the computer room equipment, and that the only power cabling which may be required to be installed in the passage 30 is the power delivery cable from the uninterruptible power supply to the respective installed rack mounted power distribution units. Thus, if for example an initial computer room installation requires only the delivery of, say, 150 kW (although it may ultimately require 450 kW in a few years) then instead of installing a power distribution unit capable of distributing 450 kW, it is possible only to install, say, five small rack mounted power distribution units capable of distributing 30 kW each. Moreover, the small power distribution units are such that they will be rack mounted in the same cabinets as the rack mounted critical loads that they will supply. Therefore, there is no additional requirement for reinforced flooring beneath a highly overrated power distribution unit, and there is no requirement for initial capital costs beyond that which is required at that time. Still further, as explained above, because there is no cable congestion in the passage 30, greater cooling efficiency for the rack mounted critical loads may be obtained, possibly at a lower cost.

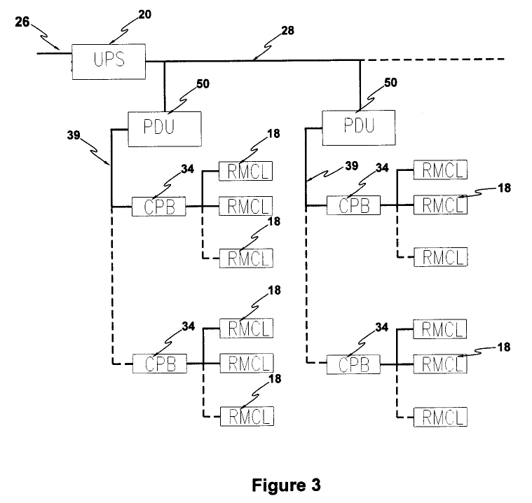

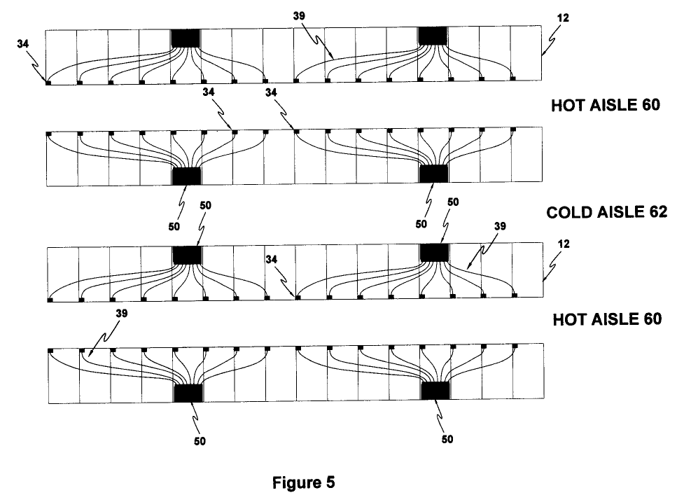

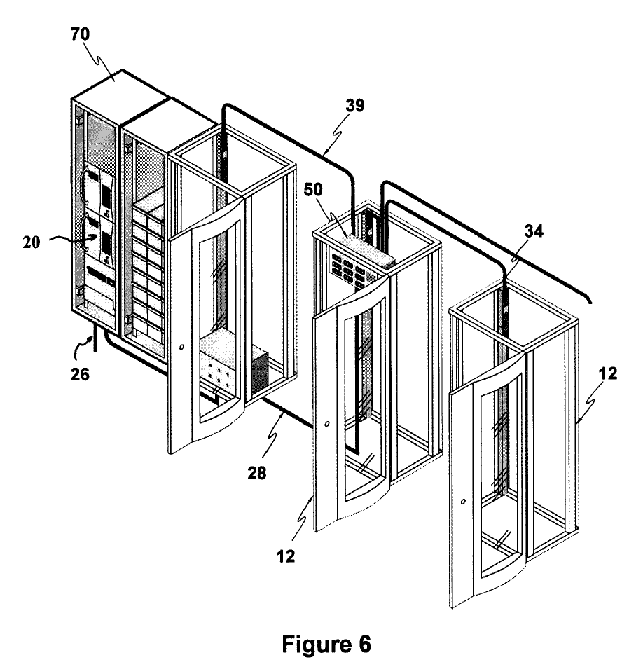

Applicant now refers to FIGS. 2 and 3. These figures diagrammatically and schematically illustrate some of the principal features of the present invention; and since many of the installed devices which are placed into a computer room are the same whether or not they are placed into a prior art computer room or into one in keeping with the present invention, the same reference numerals are employed as have been employed in reference to FIGS. 1 and 4. However, it will be noted that the rack mounted power distribution units shown in FIGS. 2 and 3 (as well as in FIGS. 5 and 6) are designated by the numeral 50. This is so as to distinguish the rack mounted power distribution units which are employed by the present invention, and which are distributed throughout the computer room, from the single, centrally located, large power distribution unit 22 of the prior art. Moreover, it will be stressed that the power distribution units 50 which are in keeping with present invention are rack mounted in some of the same cabinets 12 as the rack mounted critical loads 18 are mounted. More specific details of the configuration of each of the power distribution units are discussed in a co-pending application, Ser. No. ______, filed Jul. 26, 2007, the teachings of which are incorporated herein by reference.

Thus, it will be seen in FIG. 2 that there is substantially unimpeded air flow as shown by arrows 40; and that the only cable installed within the passage 30 is cable 28 which distributes conditioned power from the uninterruptible power supply 20 to as many rack mounted power distribution units 50 as are installed at that time. The scalability of the power distribution system in keeping with the present invention will be very evident from a brief review of FIGS. 2 and 3.

Each power cable 39 is short and has conventional plug and socket terminations—much like an ordinary extension cord. Thus, it may be considered that the connection of any power distribution unit 50 to any cabinet 12 is similar to any “plug and play” device.

Turning now to FIG. 5, the advantages of the present invention will be clearly understood by comparing that figure to FIG. 4. First, the extensive use of dedicated power cabling 38 is obviated, thereby clearing the cable congestion within the passage 30. Also, by distributing a plurality of power distribution units 50 throughout the computer room, all of which are rack mounted in cabinets 12, there is no additional requirement for special hardware or mounting cabinets or the like in order to accommodate the power distribution units 50. Moreover, the connections of the power distribution units to the cabinets 12, using cables 29, may be effected by any computer room personnel, rather than by a certified electrician.

Some explanation of the terms “hot aisle” and “cold aisle” is given. Typically, air flow over the rack mounted critical loads 18 is arranged so as to flow in one direction, from front to back. Accordingly, air flow from the passage 30 will come up into the cold aisle 62, across the rack mounted critical loads 18, and into the hot aisle 60—which, it should be obvious, will have a higher temperature than that in the cold aisle 62.

An example of the available power for distribution to the rack mounted critical loads in installations as they are shown in FIGS. 4 and 5, is now given. In an installation such as that which is shown in FIG. 4, there are only 63 cabinets 12 available for rack mounted critical loads; and the maximum average capacity of the rack mounted critical loads can only be 2.5 kW per rack or critical load. There are only 162 kW of conditioned electrical power available. In contradistinction thereto, in a system in keeping with FIG. 5, all 64 cabinets 12 are available except for a small portion of only those cabinets where the rack mounted power distribution units 50 are installed. The maximum average capacity per rack or critical load can be as high as 4.5 kW, and there can be 288 kW of conditioned electrical power available. All of this is, of course, in the same installed space in a computer room, in each instance.

Finally, turning now to FIG. 6, a perspective view of a portion of a typical installation in keeping with present invention is shown. Here, the uninterruptible power supply 20 is shown in its own rack 70, and the cabling to supply power to a rack mounted power distribution unit 50 is again shown at 28. However, because the cable runs for the power supply cables 39—which may also include other computer related wiring—are short, because they only have to run to reasonably close or adjacent cabinets 12, and because they are required to carry only as much power as will be delivered to the respective cabinet power buses 34, the cables 39 are relatively light, and are not large. Therefore, they may be, and usually are, run in the space over the cabinets 12. As noted previously, this arrangement precludes cable congestion within the passage 30; and permits the installation of additional cabinets, rack mounted power distribution units 50, and distribution cables 38, without disruption to the remaining equipment installed in the computer room. And of course, the capital cost is lower and put off until later than would have been the case in a prior art computer room.

It is obvious to those skilled in the art that redundancy can be provided simply by installing two rack mounted power distribution units 50 in their respective cabinets 12. The additional rack mounted power distribution units 50 are connected in parallel to the respective already existing rack mounted power distribution units that are in place.

The advantages of prospectively lower capital costs, and in any event more efficient operation of a computer room having a distributed electrical power system which is scalable as the electrical power requirements of the computer room increase, are clearly evident from the above discussion.

Other modifications and alterations may be used in the design and manufacture of the apparatus of the present invention without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

Moreover, the word “substantially” when used with an adjective or adverb is intended to enhance the scope of the particular characteristic; e.g., substantially unimpeded is intended to mean, in the context used, that there is little or no obstruction which will adversely effect the flow of air.

What is claimed is:

1. A scalable electrical power distribution system for use in computer rooms in which a plurality of computer servers and other computer-related devices are mounted in standard racks and cabinets therefor;
wherein said power distribution system comprises an uninterruptible power supply for delivering conditioned electrical power to rack mounted critical loads in the computer room, which critical loads may be computer servers and other computer-related devices;
at least one rack mounted power distribution unit interposed between said uninterruptible power supply and said critical loads, and adapted to distribute up to a predetermined amount of conditioned electrical power to a plurality of rack mounted critical loads, and to interpose an electrical breaker between the power distribution unit and each rack mounted critical load or a predetermined group of rack mounted critical loads;
wherein the rack mounted power distribution unit is rack mounted in a cabinet which may also include at least one rack mounted critical load mounted therein;
wherein, when the power demand of the rack mounted critical loads connected to said at least one rack mounted power distribution unit exceeds said predetermined amount of conditioned electrical power, a further rack mounted power distribution unit may be placed in a further cabinet and connected to said uninterruptible power supply so as to distribute conditioned electrical power through breakers to the additional rack mounted critical loads; and
wherein each rack mounted power distribution unit may be mounted in any cabinet in said computer room, and may be moved from one cabinet to another;
whereby said electrical power distribution system is scalable as to the number of rack mounted critical loads and their associated rack mounted power distribution units that may be installed in the computer room.

2. The scalable power distribution system of claim 1, wherein said plurality of cabinets are positioned on a raised floor below which is a passage in which electrical cabling may be placed, and through which conditioned air having a predetermined temperature and humidity is blown.

3. The scalable electrical power distribution system of claim 2, wherein only the necessary electrical power supply cabling for the uninterruptible power supply is placed in the passage below the raised computer room floor, and the power distribution cabling and any other computer-related cabling for the rack mounted critical loads associated with each rack mounted power distribution unit may be placed in a location chosen from the group of locations consisting of being placed in said passage, being above said floor, and being above the cabinets in which the respective rack mounted critical loads for each respective rack mounted power distribution unit are mounted.

4. The scalable electrical power distribution system of claim 3, wherein a cabinet power bus is mounted in each cabinet, and the power for each cabinet is delivered to the respective cabinet power bus from the rack mounted power distribution unit.

5. The scalable electrical power distribution system of claim 3, wherein said power distribution cabling and other computer-related cabling are positioned above the cabinets in which the respective rack mounted critical loads for each respective rack mounted power distribution unit are mounted.

6. The scalable electrical power distribution system of claim 1, wherein when the rack mounted critical load power requirements exceed the power rating of the uninterruptible power supply and the installed rack mounted power distribution units, the uninterruptible power supply may be replaced, or an additional uninterruptible power supply may be put into place in the computer room to be associated with rack mounted additional power distribution units as required.

7. The scalable electrical power distribution system of claim 1, wherein redundancy may be installed by placing two rack mounted power distribution units in parallel for each group of rack mounted critical loads associated with any one rack mounted power distribution unit.
